(19) United States
(12) Patent Application Publication
(10) Pub. No.: US 2025/0362820 A1
(43) Pub. Date: Nov. 27, 2025

(54) TECHNIQUES FOR TRANSITIONING BETWEEN FIRMWARE MODES AT A MEMORY SYSTEM

(71) Applicant: Micron Technology, Inc., Boise, ID (US)

(72) Inventors: Oyvind Haehre, Loveland, CO (US); John J. Kane, Westminster, CO (US); Thibash Rajamani Balakrishnan, Bangalore (IN)

(21) Appl. No.: 19/195,466

(22) Filed: Apr. 30, 2025

Related U.S. Application Data
(60) Provisional application No. 63/651,876, filed on May 24, 2024.

(51) Int. Cl. G06F 3/06

(52) U.S. Cl. CPC G06F 3/0634; G06F 3/0604; G06F 3/0679

(57) ABSTRACT

Methods, systems, and devices for techniques for transitioning between firmware modes at a memory system are described. The described techniques provide for a memory system to enter a management mode associated with facilitating a firmware mode transition based on identifying a new firmware download from a host system. While operating in the management mode, the memory system may support one or more verification operations associated with a transition from a first firmware mode to a second firmware mode. For instance, the memory system may identify whether enough blocks of the memory system are available for firmware validation and migration, may adjust namespaces associated with the first firmware mode, may reset portions of data and mapping information stored to the memory system, or any combination thereof, among other functions associated with formatting the memory system for a firmware mode transition.

### CROSS REFERENCE

The present application for patent claims priority to U.S. Patent Application No. 63/651,876 by Haehre et al., entitled “TECHNIQUES FOR TRANSITIONING BETWEEN FIRMWARE MODES AT A MEMORY SYSTEM,” filed May 24, 2024, which is assigned to the assignee hereof, and which is expressly incorporated by reference in its entirety herein.

### TECHNICAL FIELD

The following relates to one or more systems for memory, including techniques for transitioning between firmware modes at a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports techniques for transitioning between firmware modes at a memory system in accordance with examples as disclosed herein.

FIG. 2 shows an example of a flowchart that supports techniques for transitioning between firmware modes at a memory system in accordance with examples as disclosed herein.

FIG. 3 shows a block diagram of a memory system that supports techniques for transitioning between firmware modes at a memory system in accordance with examples as disclosed herein.

FIG. 4 shows a block diagram of a host system that supports techniques for transitioning between firmware modes at a memory system in accordance with examples as disclosed herein.

FIGS. 5 and 6 show flowcharts illustrating a method or methods that support techniques for transitioning between firmware modes at a memory system in accordance with examples as disclosed herein.

### DETAILED DESCRIPTION

Memory systems may be configured to support various firmware modes associated with operating hardware and other aspects of the memory systems. For example, a memory system may support a block-based firmware mode (e.g., an input/output namespace (ION) mode associated with firmware development) and a zoned namespace (ZNS) firmware mode (e.g., which may improve in-field performance), among other examples. In some examples, different firmware modes may be associated with different command sets (e.g., non-volatile memory (NVM) command sets), which may indicate data storage operations and configurations for a respective firmware mode (e.g., a block-based or zoned drive storage configuration), among other aspects. In some cases, the memory system may be unable to support different command sets in a same firmware binary (e.g., indicative of the firmware mode). As such, different firmware binaries may be established to support selecting a firmware binary for a desired firmware mode. However, firmware architectures associated with different firmware modes may be different, and some memory systems may not be able to transition between different firmware modes based on architectural constraints or limits. That is, some memory systems may either support a first firmware mode or a second firmware mode, but may not support both.

Techniques described herein provide for a memory system to support firmware mode transitions between multiple modes. To support the firmware mode transitions, the memory system may, in response to detecting a download of a new firmware at the memory system (e.g., from a host system), enter a limited function mode (LFM) (e.g., a management mode) associated with facilitating the firmware mode transition. The LFM may be associated with a reduced command set. For example, a quantity of commands that the memory system supports (e.g., can execute) while operating in the LFM may be relatively small (e.g., relative to quantities of commands included in command sets associated with other firmware modes). The reduced command set and other aspects of the LFM may provide for the memory system to support one or more verification operations associated with a transition from a first firmware mode to a second firmware mode. For instance, while operating in the LFM, the memory system may identify whether enough blocks of the memory system are available for firmware validation and migration, may adjust (e.g., detach) namespaces associated with the first firmware mode, may reset portions of data and mapping information stored to the memory system, or any combination thereof, among other functions associated with formatting the memory system for a firmware mode transition. In some cases, operating the in LFM may improve firmware mode transitions by the memory system during in field operations, among other advantages.

In addition to applicability in memory systems as described herein, techniques for transitioning between firmware modes may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds and improving compatibility of a memory system with multiple different types of firmware and host systems, which may decrease processing or latency times, improve response times, or otherwise improve user experience, among other benefits.

In addition to applicability in memory systems described herein, techniques for transitioning between firmware modes may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by enabling firmware mode transitions during operation of the electronic devices and systems, and may incur lower latency costs, among other benefits.

In addition to applicability in memory systems as described herein, techniques for transitioning between firmware modes may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by improving the endurance of a drive of an electronic device, which may extend the life of electronic devices and thereby reduce electronic waste, among other benefits.

Features of the disclosure are illustrated and described in the context of systems, devices, and circuits. Features of the disclosure are further illustrated and described in the context of flowcharts.

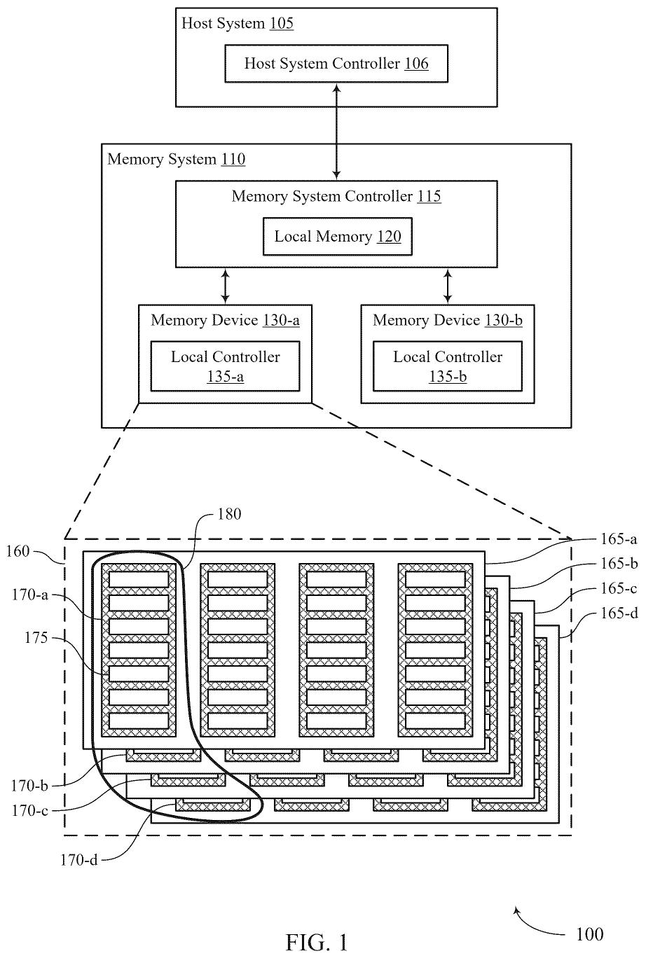

FIG. 1 shows an example of a system 100 that supports techniques for transitioning between firmware modes at a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells (e.g., penta-level cells (PLCs) and other types of memory cells configured to store greater quantities of information). Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples, a memory system 110 may be configured to support various firmware modes associated with operating hardware of the memory system 110. As an example, the memory system 110 may support an ION firmware mode associated with firmware development and testing, which may be an example of a block-based data storage scheme. For instance, while operating according to the ION firmware mode, the memory system 110 may store and maintain data in blocks 170 of one or more memory devices 130, and may identify locations of stored data using logical-to-physical (L2P) tables which include mappings indicating relationships between logical addresses and physical addresses of the data. As another example, the memory system 110 may support a ZNS firmware mode, where one or more zones may be configured to store sets of contiguous information. For example, the ZNS firmware mode may improve an endurance of the memory system 110 due to storing and accessing data in a sequential fashion, which may reduce a quantity of accesses to memory cells of the memory system 110.

In some examples, different firmware modes may be associated with different command sets. For example, the ION firmware mode may include one or more commands associated with formatting and managing L2P tables storing mapping information for various regions of memory in the memory system 110 and the ZNS firmware mode may include one or more commands associated with activating and managing zones opened at various portions of memory in the memory system 110. In some cases, the memory system 110 may be unable to support the different command sets using a same firmware binary (e.g., the memory system 110 may select different firmware binaries for different firmware modes). Additionally, or alternatively, in some cases, the memory system 110 may be unable to transition between firmware modes due to significant architectural differences between different firmware modes.

The described techniques provide for a memory system 110 to support transitions between firmware modes associated with different command sets. The transitions may occur during operation of the memory system 110 or prior to deployment of the memory system 110 (e.g., during manufacture), or both. In some cases, the memory system 110 may enter a LFM (e.g., a management mode) associated with facilitating a firmware mode transition based on identifying a new firmware download from a host system 105. The LFM may be associated with a reduced command set (e.g., relative to command sets associated with firmware modes) such that the memory system 110 may perform one or more verification operations associated with a transition from a first firmware mode to a second firmware mode. For instance, while operating in the LFM, the memory system 110 may identify whether enough blocks of the memory system 110 are available for firmware validation and migration, may adjust (e.g., detach) namespaces associated with the first firmware mode, may reset portions of data and mapping information stored to the memory system 110, or any combination thereof, among other functions associated with formatting the memory system 110 for a firmware mode transition. In some cases, operating the in LFM may improve firmware mode transitions by the memory system 110 during in field operations and may mitigate adverse performance effects (e.g., latency and/or overhead) associated with such transitions.

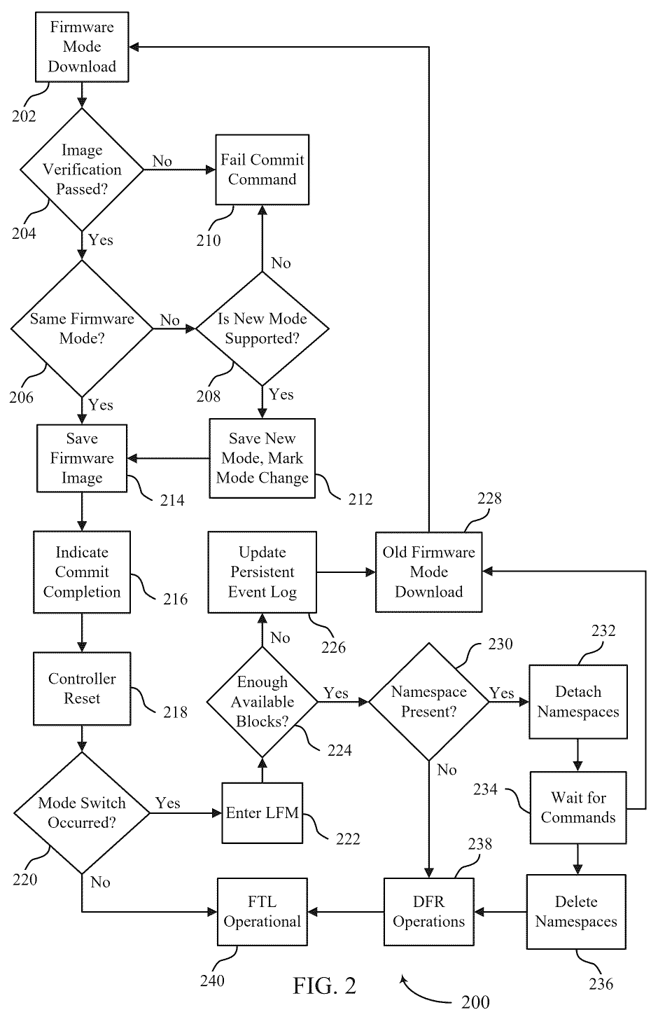

FIG. 2 shows an example of a flowchart 200 that supports techniques for transitioning between firmware modes at a memory system in accordance with examples as disclosed herein. The flowchart 200 may implement, or be implemented by, one or more aspects of the system 100. For example, the flowchart 200 may show an example of operations performed by a memory system based on information received from a host system, which may be examples of corresponding devices described with reference to FIG. 1. In some cases, the flowchart 200 may include operations of the memory system associated with performing a transition between firmware modes, such as between an ION mode and a ZNS mode supported by the memory system. Alternative examples of the following may be implemented, where some processes are performed in a different order than described or are not performed. In some cases, processes may include additional features not mentioned below, or further processes may be added.

At 202, the memory system may receive a firmware download (e.g., an indication of a new firmware and corresponding firmware mode). In some cases, the firmware download may indicate a new firmware for the memory system to use for subsequent operations. For example, prior to receiving the firmware download, the memory system may operate in a first firmware mode using a first firmware, and the firmware download may include an indication of a second firmware for the memory system. In some examples, the memory system may receive the firmware download from a host system associated with the memory system. The firmware download may include a firmware commit start, which may indicate a start time associated with a commit action for committing the new firmware (e.g., a quantity of hours, such as 0 hours, 1 hour, 2 hours, or the like). The second firmware downloaded at the memory system may be associated with a same firmware mode as the first firmware, or a different firmware mode. For example, the second firmware may be associated with the same or different command sets and associated access parameters.

At 204, the memory system may determine whether a firmware image verification is passed. For example, the firmware download may include the firmware image of the second firmware and the memory system verify that the firmware image has been successfully downloaded and committed. If the memory system determines that the image verification has passed, the memory system may proceed to step 206 of the flowchart 200. Alternatively, if the memory system determines that the image verification has failed, the memory system may proceed to step 210 of the flowchart 200.

At 206, the memory system may determine whether a second firmware mode associated with the second firmware is the same as a first firmware mode in which the memory system is currently operating (e.g., a current firmware mode). For example, when the firmware image is activated for the second firmware, the memory system may store a first command set supported by the first firmware mode (e.g., a current command set) in persistent memory for each firmware slot of the memory system (e.g., slot_fw_command_set_mode). In some cases, to indicate the mode of the second firmware during the download of the second firmware, the host system may include a field in the firmware image header indicating a second command set associated with the second firmware and corresponding second firmware mode (e.g., fw_command_set_mode). The memory system may detect whether a mode switch has occurred (e.g., whether the first firmware mode and the second firmware mode are different) by comparing the first command set and the second command set. If the memory system identifies that the first command set and the second command set are the same, the memory system may proceed to step 214 of the flowchart 200. Alternatively, if the memory system identifies that the first command set and the second command set are different, the memory system may proceed to step 208 of the flowchart 200.

At 208, the memory system may determine whether the second firmware mode is supported by the memory system. For example, the memory system may determine whether the second command set includes one or more commands that the memory system is able to execute (e.g., according to an environmental status of the memory system, such as whether the memory system is in a production or development stage, among other factors). If the memory system determines that the second firmware mode is supported, the memory system may proceed to step 212 of the flowchart 200. Alternatively, if the memory system determines that the second firmware mode is not supported, the memory system may proceed to step 210 of the flowchart 200.

At 210, the memory system may determine that the firmware download and commit has failed. The failure to download and commit the second firmware mode may be due to the image verification failing at 204, the memory system determining that the second firmware mode is not supported at 208, or both, among other examples. In some examples, the memory system may transmit an indication to the host system that the commit of the second firmware mode has failed. In some cases, the memory system may continue to operate in the first firmware mode based on determining that the second firmware commit has failed, and the flowchart 200 may terminate.

At 212, the memory system may store information for the second firmware mode and may mark that a mode switch has been detected. For example, based on determining that that the memory system supports the second firmware mode at 208, the memory system may store information indicating the second command set associated with the second firmware mode for a slot in persistent memory (e.g., slot_fw_command_set_mode). Additionally, when the memory system detects a mode switch has occurred, the memory system may update mode switch information (e.g., mode_switch_state) in persistent memory to indicate that the mode switch has been detected. For example, the memory system may set the mode switch information to a first value, which may indicate that a change in firmware mode has been detected by the memory system. In some examples, the persistent memory may be a file system area (FSA) of the memory system, which may be an example of NAND-based storage for firmware use including saving firmware and bootloader images.

At 214, the memory system may save a firmware image for the second firmware mode. For example, the memory system may save the firmware image to a corresponding firmware slot. In some examples, the memory system may store the firmware image for the second firmware mode based on identifying that the second firmware mode is the same as the first firmware mode at 206 or based on saving the new firmware mode information at 212, or both.

At 216, the memory system may transmit, to the host system, an indication that the commit of the second firmware mode is complete. For example, the memory system may transmit the indication based on saving the firmware image for the second firmware mode. In some examples, the memory system may transmit the indication based on receiving a host initiated commit (e.g., a firmware commit command).

At 218, the memory system may restart a controller of the memory system (e.g., a memory system controller 115 described with reference to FIG. 1). For example, after transmitting the indication that the commit of the second firmware mode is complete, the memory system may receive a reset command from the host system indicating to reset the controller of the memory system. Additionally, or alternatively, the memory system may restart the controller as part of processing a firmware commit command from the host system, such as when the firmware commit command indicates to perform commit actions without waiting for an explicit controller reset command from the host (e.g., the firmware commit command includes an activate immediate commit action indication). In some cases, to execute the reset command, the memory system may power cycle the controller by transitioning the controller to a low-power state before returning the controller to a high power state (e.g., a reboot). In some examples, performing the controller reset may support the memory system transitioning from the first firmware mode to the second firmware mode.

At 220, the memory system may determine whether a firmware mode switch has occurred. For example, after performing the controller reset, the memory system may identify a status of the mode switch information stored to the persistent memory to identify whether the firmware mode switch has occurred. In some examples, the memory system may identify that the mode switch information is set to the first value indicating that the mode switch has been detected (e.g., at 212). In some cases, the first value may further indicate a status of the mode switch after a first boot (e.g., the controller restart initiated by the host system). If the memory system identifies that the mode switch has occurred based on the mode switch information, the memory system may proceed to step 222 of the flowchart 200. Alternatively, if the memory system identifies that the mode switch has not occurred (e.g., the memory system identified the same firmware mode at 206), the memory system may proceed to step 240 of the flowchart 200. In such cases, the memory system may utilize the new firmware without performing additional mode transition operations as described herein, as the new firmware may support a same command set and other parameters as the initial firmware executed by the memory system prior to the download.

At 222, the memory system may transition from the first firmware mode to a management mode. The management mode may be referred to as a LFM and may be associated with a reduced command set relative to the first command set and the second command set. For example, while operating in the management mode, the memory system may not perform one or more functions associated with the first firmware mode or the second firmware mode, such as L2P reconstruction or block scanning, among other operations. The management mode may support one or more verification operations associated with the transition from the first firmware mode to the second firmware mode. Additionally, or alternatively, the memory system may modify the value of the mode switch information (e.g., from the first value to a second value), where the modified value may indicate that the memory system is operating in the management mode. For example, based on modifying the mode switch information and the mode switch information being stored to the persistent memory, the memory system may determine to re-enter the LFM if the memory system experiences an asynchronous power loss (APL) based on identifying the mode switch information being set to the modified value.

At 224, the memory system may determine whether enough blocks are available for completing the transition from the first firmware mode to the second firmware mode. For example, the memory system may determine, based on the one or more verification operations and in accordance with operating in the management mode, whether a quantity of available blocks in the memory system satisfies a threshold quantity associated with the transition. In some cases, the threshold quantity of available blocks may be associated with the data storage architecture of the second firmware mode. Additionally, or alternatively, the memory system may identify whether blocks are available in persistent (e.g., non-volatile) memory, non-persistent (e.g., volatile) memory, or both to support operating in the second firmware mode for subsequent operations. If the memory system determines that the quantity of available blocks satisfies the threshold quantity, the memory system may proceed to step 230 of the flowchart 200. Alternatively, if the memory system determines that the quantity of available blocks fails to satisfy the threshold quantity, the memory system may proceed to step 226 of the flowchart 200.

At 226, the memory system may update a persistent event log based on determining that the quantity of available blocks fails to satisfy the threshold value. For example, the memory system may update an entry of the persistent event log to indicate, to the host device, that the memory system does not support the transition from the first firmware mode to the second firmware mode (e.g., event type 04h for a power-on or reset event, among other examples).

At 228, the memory system may receive, from the host system, a download for the first firmware mode (e.g., the old firmware mode). For example, the memory system may receive an indication to download the first firmware and transition back to the first firmware mode based on updating the persistent event log to indicate that the activation of the second firmware mode has failed, based on a decision by the host system, based on one or more other parameters or factors, or any combination thereof. The host system may indicate to download the old firmware to revert to the first command set for performing subsequent operations. In such examples, the memory system may return to step 202 of the flowchart 200 and may perform the operations of the flowchart 200 according to the download of the first firmware mode. For example, the commit and activate process for the first firmware may result in the memory system detecting that an existing namespace corresponds to the firmware being activated and transitioning from the LFM back to the first firmware mode.

At 230, the memory system may determine, based on a success of one or more first verification procedures (e.g., based on a quantity of available blocks satisfying the threshold at 224), whether one or more namespaces associated with the first firmware mode are present in the memory system (e.g., a namespace identification operation). For example, the one or more namespaces may be maintained by the memory system to support identification and reference to various objects and functions supported by the first firmware mode. In some examples, the one or more namespaces associated with the first firmware mode may be incompatible with the second firmware mode. If the memory system identifies that the one or more namespaces are present, the memory system may proceed to step 232 of the flowchart 200. Alternatively, if the memory system identifies that the one or more namespaces are not present, the memory system may proceed to step 238 of the flowchart 200.

At 232, the memory system may detach the one or more namespaces associated with the first firmware mode based on identifying that the one or more namespaces are present. In some examples, detaching the namespaces may prevent the memory system from processing one or more subsequent commands (e.g., I/O commands) during the firmware mode transition (e.g., due to the namespace being incompatible based on an unsupported command set). For example, based on detaching the namespaces, the memory system may refrain from processing namespace formatting commands (e.g., returning an error of 0Ah invalid format or VU error code, among other examples), namespace management commands (e.g., a create command may fail due to a quantity of supported namespaces being exceeded), namespace attach commands (e.g., an I/O command set may not be supported due to a corresponding namespace being detached), or any combination thereof.

At 234, the memory system may wait for one or more commands from the host system. In some cases, if the memory system identifies that the transition to the second firmware mode is supported (e.g., at 224), the memory system may not transmit an indication of success to the host system, and may instead wait to receive subsequent commands from the host system to proceed with the firmware mode transition. As such, in some examples, if the host system does not receive any indications from the memory system (e.g., indicating the firmware activation failure) for at least a threshold time period, the host system may transmit a command to the memory system to initiate (e.g., trigger) the mode transition. In some examples, the command may indicate that the memory system is to adjust the one or more namespaces of the memory system and complete the firmware mode transition from the first firmware mode to the second firmware mode for subsequent operation. For example, the command may include a namespace management selection (e.g., SEL=Delete) and namespace identification (e.g., namespace identifier (NSID)=FFFFFFFFh) information indicating to delete the namespaces associated with the first firmware mode. In such examples, the memory system may proceed to step 236 of the flowchart 200. Alternatively, the command may include an indication to download the first firmware mode (e.g., revert back to the first firmware mode and not complete the transition to the second firmware mode), such as if the host system determines that the memory system is to remain in the first firmware mode for subsequent operations, if the host system receives some error indication from the memory system, based on one or more other parameters, or any combination thereof. In such examples, the memory system may proceed to step 228 of the flowchart 200 and may retain the detached namespaces to support transitioning from the LFM back to the first firmware mode.

At 236, the memory system may execute the command to adjust the one or more namespaces of the memory system. For example, the memory system may delete the detached namespaces from the memory system, which may support the memory system completing the firmware mode transition to the second firmware mode. In some cases, deleting the namespace may support the memory system performing drive framework reset (DFR) and low-level format (LLF) operations to complete the firmware mode transition.

At 238, the memory system may perform one or more DFR operations in accordance with operating in the LFM, which may be an example of methods used by the memory system to perform a LLF of the memory system. For example, the one or more DFR operations may include the memory system quiescing flash translation layer (FTL) modules and suspending subsequent requests for the FTL modules, synchronizing one or more write cursors of the memory system (e.g., to a data stripe boundary), resetting the one or more write cursors of the memory system, or any combination thereof. Additionally, or alternatively, the DFR operations may include the memory system updating block retirement information, where the memory system may preserve a grown bad block (GBB) list (e.g., bad blocks identified during drive operation) and a burn in bad block (BIBB) list (e.g., bad blocks existing from an initial drive state) such that the memory system is aware of the location of bad blocks (e.g., blocks unsuitable for data storage) when operating in the second firmware mode. In some examples, the DFR operations may include the memory system resetting L2P datastores (e.g., removing L2P mapping data, such as when transitioning from an ION firmware mode to a ZNS firmware mode), resetting data included in one or more other datastores, and setting the datastores of the memory system (e.g., set to TABLE LOADED). In such examples, the memory system may preserve one or more block characteristics, such as a program-erase cycle (PEC) count associated with each block of the memory system (e.g., since the firmware mode transition is not a drive manufacturing process, where PEC counts may otherwise be reset), which may support the memory system avoiding excessive wear on certain blocks while operating in the second firmware mode. The memory system may transfer data stored to the blocks of the memory system to a garbage pool (e.g., to support erasing the data during subsequent operations) and may flush FTL data to NAND memory of the memory system. In some cases, after performing the DFR operations, the memory system may proceed to step 240 of the flowchart 200.

At 240, the memory system may determine that the FTL is operational. For example, based on executing the DFR operations to perform the LLF of the drive, the memory system may set an FTL state machine status to operational, which may indicate that the memory system is operating in the second firmware mode for subsequent operations. The memory system and host system may then communicate to store and access data in accordance with the second command set associated with the second firmware mode.

Such techniques may support the memory system performing firmware mode transitions without impacting in-field performance of the memory system (e.g., the firmware mode transition may be performed in background processes and may be transparent to the host system). Further, transitioning firmware modes may support improved drive endurance, such as when the memory system transitions to a ZNS firmware mode to reduce wear associated with frequently accessing memory cells, among other advantages.

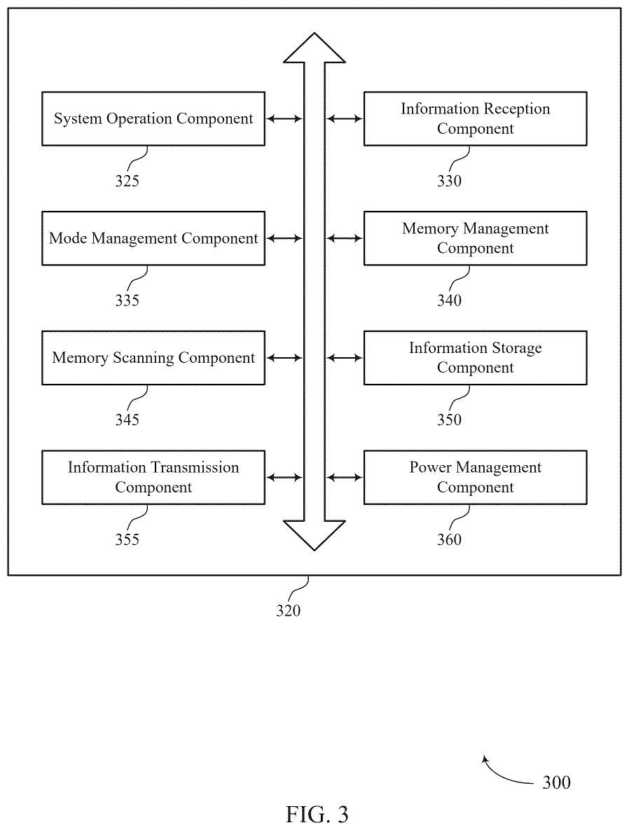

FIG. 3 shows a block diagram 300 of a memory system 320 that supports techniques for transitioning between firmware modes at a memory system in accordance with examples as disclosed herein. The memory system 320 may be an example of aspects of a memory system as described with reference to FIGS. 1 and 2. The memory system 320, or various components thereof, may be an example of means for performing various aspects of techniques for transitioning between firmware modes at a memory system as described herein. For example, the memory system 320 may include a system operation component 325, an information reception component 330, a mode management component 335, a memory management component 340, a memory scanning component 345, an information storage component 350, an information transmission component 355, a power management component 360, or any combination thereof. Each of these components, or components of subcomponents thereof (e.g., one or more processors, one or more memories), may communicate, directly or indirectly, with one another (e.g., via one or more buses).

The system operation component 325 may be configured as or otherwise support a means for operating in a first firmware mode of the memory system, the first firmware mode associated with a first command set for accessing the memory system. The information reception component 330 may be configured as or otherwise support a means for receiving an indication of a second firmware mode for the memory system, the second firmware mode associated with a second command set for accessing the memory system that is different than the first command set. The mode management component 335 may be configured as or otherwise support a means for transitioning, based at least in part on the first command set being different than the second command set, from the first firmware mode to a management mode associated with a reduced command set relative to the first command set and the second command set, where the management mode supports one or more verification operations associated with a transition from the first firmware mode to the second firmware mode. In some examples, the mode management component 335 may be configured as or otherwise support a means for determining whether to transition from the management mode to the second firmware mode based at least in part on the management mode supporting the one or more verification operations.

In some examples, the system operation component 325 may be configured as or otherwise support a means for performing the one or more verification operations according to the management mode. In some examples, the information reception component 330 may be configured as or otherwise support a means for receiving, based at least in part on the one or more verification operations and a threshold time period, a command to adjust one or more namespaces associated with the first firmware mode, where determining whether to transition from the management mode to the second firmware mode is further based at least in part on the command. In some examples, the memory management component 340 may be configured as or otherwise support a means for adjusting the one or more namespaces based at least in part on the command. In some examples, the mode management component 335 may be configured as or otherwise support a means for transitioning from the management mode to the second firmware mode based at least in part on adjusting the one or more namespaces.

In some examples, the system operation component 325 may be configured as or otherwise support a means for performing the one or more verification operations according to the management mode. In some examples, the information reception component 330 may be configured as or otherwise support a means for receiving, based at least in part on the one or more verification operations, a second indication of the first firmware mode, where determining whether to transition from the management mode to the second firmware mode is further based at least in part on the command. In some examples, the mode management component 335 may be configured as or otherwise support a means for transitioning from the management mode to the first firmware mode based at least in part on the second indication.

In some examples, to support determining whether to transition from the management mode to the second firmware mode, the memory scanning component 345 may be configured as or otherwise support a means for determining, based at least in part on the one or more verification operations and in accordance with operating in the management mode, whether a quantity of available blocks in the memory system satisfies a threshold quantity associated with the transition to the second firmware mode.

In some examples, the memory scanning component 345 may be configured as or otherwise support a means for determining that the quantity of available blocks satisfies the threshold quantity. In some examples, the mode management component 335 may be configured as or otherwise support a means for transitioning from the management mode to the second firmware mode based at least in part on a command and the quantity of available blocks satisfying the threshold quantity.

In some examples, the memory scanning component 345 may be configured as or otherwise support a means for determining that the quantity of available blocks does not satisfy the threshold quantity. In some examples, the information transmission component 355 may be configured as or otherwise support a means for transmitting, based at least in part on determining that the quantity of available blocks does not satisfy the threshold quantity, a second indication that the memory system does not support the transition from the first firmware mode to the second firmware mode. In some examples, the information reception component 330 may be configured as or otherwise support a means for receiving, based at least in part on transmitting the second indication, a third indication of the first firmware mode. In some examples, the mode management component 335 may be configured as or otherwise support a means for transitioning from the management mode to the first firmware mode based at least in part on the third indication.

In some examples, to support determining whether to transition from the management mode to the second firmware mode, the mode management component 335 may be configured as or otherwise support a means for determining to transition from the management mode to the second firmware mode based at least in part on an absence of namespaces in the memory system, where the one or more verification operations include a namespace identification operation.

In some examples, the memory management component 340 may be configured as or otherwise support a means for detaching, based at least in part on the one or more verification operations and in accordance with operating in the management mode, one or more namespaces from the memory system, where determining whether to transition from the management mode to the second firmware mode is based at least in part on detaching the one or more namespaces.

In some examples, the information storage component 350 may be configured as or otherwise support a means for storing mode switch information that indicates a mode switch between the first firmware mode and the second firmware mode based at least in part on the second command set being different than the first command set.

In some examples, the information reception component 330 may be configured as or otherwise support a means for receiving, after receiving the indication of the second firmware mode, a reset command. In some examples, the mode management component 335 may be configured as or otherwise support a means for determining, based at least in part on the reset command, that the mode switch information indicates the mode switch, where transitioning from the first firmware mode to the management mode is based at least in part on identifying that the mode switch information.

In some examples, the information storage component 350 may be configured as or otherwise support a means for modifying a value of the mode switch information based at least in part on transitioning from the first firmware mode to the management mode, where the modified mode switch information indicates that the memory system is operating in the management mode.

In some examples, the power management component 360 may be configured as or otherwise support a means for transitioning from a first power state to a second power state based at least in part on an asynchronous power loss at the memory system, the second power state greater than the first power state. In some examples, the mode management component 335 may be configured as or otherwise support a means for operating in the management mode after transitioning from the first power state to the second power state based at least in part on modifying the mode switch information.

In some examples, the mode switch information is stored to non-volatile memory of the memory system.

In some examples, operating in the management mode includes suspending one or more flash translation layer modules of the memory system, synchronizing one or more write cursors of the memory system, updating block retirement information of the memory system, resetting a logical-to-physical mapping for the memory system, resetting data stored to one or more datastores of the memory system, setting one or more datastore states of the memory system, flushing one or more portions of data to non-volatile memory of the memory system, or any combination thereof.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

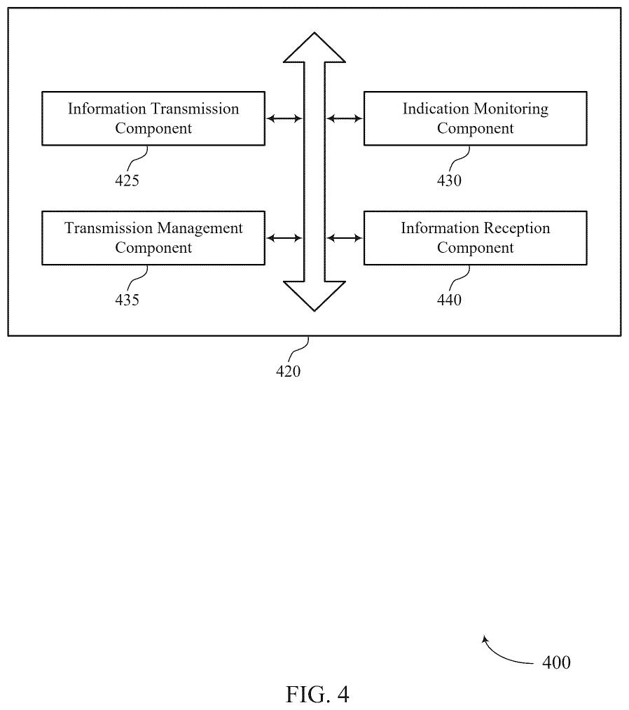

FIG. 4 shows a block diagram 400 of a host system 420 that supports techniques for transitioning between firmware modes at a memory system in accordance with examples as disclosed herein. The host system 420 may be an example of aspects of a host system as described with reference to FIGS. 1 through 3. The host system 420, or various components thereof, may be an example of means for performing various aspects of techniques for transitioning between firmware modes at a memory system as described herein. For example, the host system 420 may include an information transmission component 425, an indication monitoring component 430, a transmission management component 435, an information reception component 440, or any combination thereof. Each of these components, or components of subcomponents thereof (e.g., one or more processors, one or more memories), may communicate, directly or indirectly, with one another (e.g., via one or more buses).

The information transmission component 425 may be configured as or otherwise support a means for transmitting, to a memory system, an indication of a first firmware mode for subsequent operations by the memory system, where the first firmware mode is associated with a first command set for accessing the memory system that is different than a second command set for accessing the memory system according to a second firmware mode used by the memory system prior to transmitting the indication of the first firmware mode. The indication monitoring component 430 may be configured as or otherwise support a means for monitoring for one or more indications associated with a management mode of the memory system, where the management mode is associated with a reduced command set for accessing the memory system during a firmware mode transition. The transmission management component 435 may be configured as or otherwise support a means for determining, based at least in part on the one or more indications, whether to transmit, to the memory system, a command to adjust a plurality of namespaces of the memory system and complete the firmware mode transition to the first firmware mode for the subsequent operations.

In some examples, the one or more indications include a threshold time period, and the information transmission component 425 may be configured as or otherwise support a means for transmitting, based at least in part on an absence of signaling from the memory system during the threshold time period, the command to adjust the plurality of namespaces of the memory system and complete the firmware mode transition to the first firmware mode for the subsequent operations.

In some examples, the information reception component 440 may be configured as or otherwise support a means for receiving, based at least in part on monitoring for the one or more indications, a second indication that the memory system does not support the first firmware mode. In some examples, the information transmission component 425 may be configured as or otherwise support a means for transmitting, based at least in part on receiving the second indication, a third indication of the first firmware mode for the subsequent operations by the memory system.

In some examples, the information transmission component 425 may be configured as or otherwise support a means for transmitting, after transmitting the indication of the first firmware mode, a second command to reset the memory system, where monitoring for the one or more indications associated with the management mode is based at least in part on the second command.

In some examples, the command to adjust the plurality of namespaces of the memory system indicates to delete the plurality of namespaces of the memory system.

In some examples, the described functionality of the host system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 420, or various components thereof, may be implemented at least in part by instructions (e.g., stored in memory, non-transitory computer-readable medium) executable by such at least one processor.

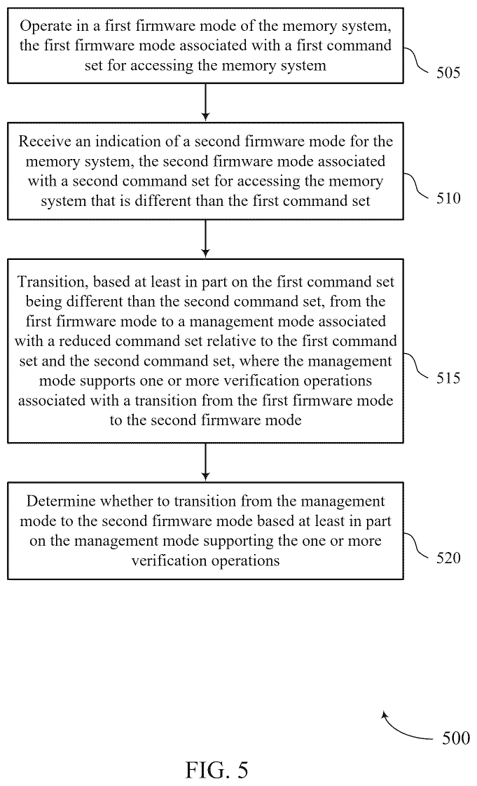

FIG. 5 shows a flowchart illustrating a method 500 that supports techniques for transitioning between firmware modes at a memory system in accordance with examples as disclosed herein. The operations of method 500 may be implemented by a memory system or its components as described herein. For example, the operations of method 500 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 505, the method may include operating in a first firmware mode of the memory system, the first firmware mode associated with a first command set for accessing the memory system. In some examples, aspects of the operations of 505 may be performed by a system operation component 325 as described with reference to FIG. 3.

At 510, the method may include receiving an indication of a second firmware mode for the memory system, the second firmware mode associated with a second command set for accessing the memory system that is different than the first command set. In some examples, aspects of the operations of 510 may be performed by an information reception component 330 as described with reference to FIG. 3.

At 515, the method may include transitioning, based at least in part on the first command set being different than the second command set, from the first firmware mode to a management mode associated with a reduced command set relative to the first command set and the second command set, where the management mode supports one or more verification operations associated with a transition from the first firmware mode to the second firmware mode. In some examples, aspects of the operations of 515 may be performed by a mode management component 335 as described with reference to FIG. 3.

At 520, the method may include determining whether to transition from the management mode to the second firmware mode based at least in part on the management mode supporting the one or more verification operations. In some examples, aspects of the operations of 520 may be performed by a mode management component 335 as described with reference to FIG. 3.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for operating in a first firmware mode of the memory system, the first firmware mode associated with a first command set for accessing the memory system; receiving an indication of a second firmware mode for the memory system, the second firmware mode associated with a second command set for accessing the memory system that is different than the first command set; transitioning, based at least in part on the first command set being different than the second command set, from the first firmware mode to a management mode associated with a reduced command set relative to the first command set and the second command set, where the management mode supports one or more verification operations associated with a transition from the first firmware mode to the second firmware mode; and determining whether to transition from the management mode to the second firmware mode based at least in part on the management mode supporting the one or more verification operations.

Aspect 2: The method, apparatus, or non-transitory computer-readable medium of aspect 1, further including operations, features, circuitry, logic, means, or instructions, or any combination thereof for performing the one or more verification operations according to the management mode; receiving, based at least in part on the one or more verification operations and a threshold time period, a command to adjust one or more namespaces associated with the first firmware mode, where determining whether to transition from the management mode to the second firmware mode is further based at least in part on the command; adjusting the one or more namespaces based at least in part on the command; and transitioning from the management mode to the second firmware mode based at least in part on adjusting the one or more namespaces.

Aspect 3: The method, apparatus, or non-transitory computer-readable medium of any of aspects 1 through 2, further including operations, features, circuitry, logic, means, or instructions, or any combination thereof for performing the one or more verification operations according to the management mode; receiving, based at least in part on the one or more verification operations, a second indication of the first firmware mode, where determining whether to transition from the management mode to the second firmware mode is further based at least in part on the command; and transitioning from the management mode to the first firmware mode based at least in part on the second indication.

Aspect 4: The method, apparatus, or non-transitory computer-readable medium of any of aspects 1 through 3, where determining whether to transition from the management mode to the second firmware mode includes operations, features, circuitry, logic, means, or instructions, or any combination thereof for determining, based at least in part on the one or more verification operations and in accordance with operating in the management mode, whether a quantity of available blocks in the memory system satisfies a threshold quantity associated with the transition to the second firmware mode.

Aspect 5: The method, apparatus, or non-transitory computer-readable medium of aspect 4, further including operations, features, circuitry, logic, means, or instructions, or any combination thereof for determining that the quantity of available blocks satisfies the threshold quantity and transitioning from the management mode to the second firmware mode based at least in part on a command and the quantity of available blocks satisfying the threshold quantity.

Aspect 6: The method, apparatus, or non-transitory computer-readable medium of any of aspects 4 through 5, further including operations, features, circuitry, logic, means, or instructions, or any combination thereof for determining that the quantity of available blocks does not satisfy the threshold quantity; transmitting, based at least in part on determining that the quantity of available blocks does not satisfy the threshold quantity, a second indication that the memory system does not support the transition from the first firmware mode to the second firmware mode; receiving, based at least in part on transmitting the second indication, a third indication of the first firmware mode; and transitioning from the management mode to the first firmware mode based at least in part on the third indication.

Aspect 7: The method, apparatus, or non-transitory computer-readable medium of any of aspects 1 through 6, where determining whether to transition from the management mode to the second firmware mode includes operations, features, circuitry, logic, means, or instructions, or any combination thereof for determining to transition from the management mode to the second firmware mode based at least in part on an absence of namespaces in the memory system, where the one or more verification operations include a namespace identification operation.

Aspect 8: The method, apparatus, or non-transitory computer-readable medium of any of aspects 1 through 7, further including operations, features, circuitry, logic, means, or instructions, or any combination thereof for detaching, based at least in part on the one or more verification operations and in accordance with operating in the management mode, one or more namespaces from the memory system, where determining whether to transition from the management mode to the second firmware mode is based at least in part on detaching the one or more namespaces.

Aspect 9: The method, apparatus, or non-transitory computer-readable medium of any of aspects 1 through 8, further including operations, features, circuitry, logic, means, or instructions, or any combination thereof for storing mode switch information that indicates a mode switch between the first firmware mode and the second firmware mode based at least in part on the second command set being different than the first command set.

Aspect 10: The method, apparatus, or non-transitory computer-readable medium of aspect 9, further including operations, features, circuitry, logic, means, or instructions, or any combination thereof for receiving, after receiving the indication of the second firmware mode, a reset command and determining, based at least in part on the reset command, that the mode switch information indicates the mode switch, where transitioning from the first firmware mode to the management mode is based at least in part on identifying that the mode switch information.

Aspect 11: The method, apparatus, or non-transitory computer-readable medium of any of aspects 9 through 10, further including operations, features, circuitry, logic, means, or instructions, or any combination thereof for modifying a value of the mode switch information based at least in part on transitioning from the first firmware mode to the management mode, where the modified mode switch information indicates that the memory system is operating in the management mode.

Aspect 12: The method, apparatus, or non-transitory computer-readable medium of aspect 11, further including operations, features, circuitry, logic, means, or instructions, or any combination thereof for transitioning from a first power state to a second power state based at least in part on an asynchronous power loss at the memory system, the second power state greater than the first power state and operating in the management mode after transitioning from the first power state to the second power state based at least in part on modifying the mode switch information.

Aspect 13: The method, apparatus, or non-transitory computer-readable medium of any of aspects 9 through 12, where the mode switch information is stored to non-volatile memory of the memory system.

Aspect 14: The method, apparatus, or non-transitory computer-readable medium of any of aspects 1 through 13, where operating in the management mode includes suspending one or more flash translation layer modules of the memory system, synchronizing one or more write cursors of the memory system, updating block retirement information of the memory system, resetting a logical-to-physical mapping for the memory system, resetting data stored to one or more datastores of the memory system, setting one or more datastore states of the memory system, flushing one or more portions of data to non-volatile memory of the memory system, or any combination thereof.

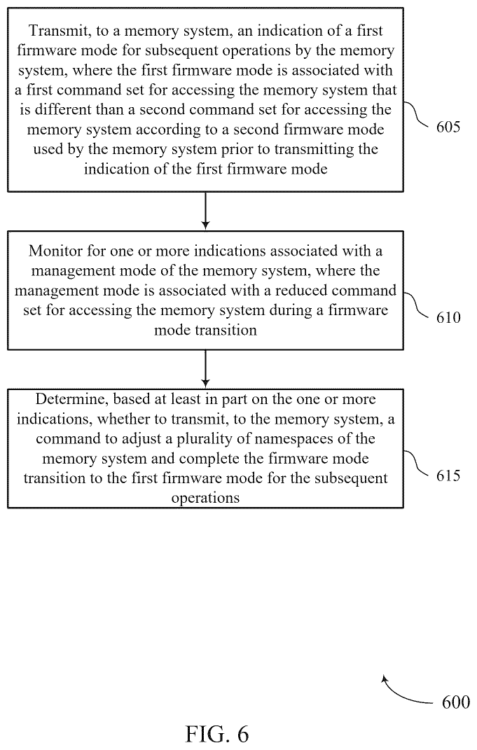

FIG. 6 shows a flowchart illustrating a method 600 that supports techniques for transitioning between firmware modes at a memory system in accordance with examples as disclosed herein. The operations of method 600 may be implemented by a host system or its components as described herein. For example, the operations of method 600 may be performed by a host system as described with reference to FIGS. 1, 2, and 4. In some examples, a host system may execute a set of instructions to control the functional elements of the device to perform the described functions. Additionally, or alternatively, the host system may perform aspects of the described functions using special-purpose hardware.

At 605, the method may include transmitting, to a memory system, an indication of a first firmware mode for subsequent operations by the memory system, where the first firmware mode is associated with a first command set for accessing the memory system that is different than a second command set for accessing the memory system according to a second firmware mode used by the memory system prior to transmitting the indication of the first firmware mode. In some examples, aspects of the operations of 605 may be performed by an information transmission component 425 as described with reference to FIG. 4.

At 610, the method may include monitoring for one or more indications associated with a management mode of the memory system, where the management mode is associated with a reduced command set for accessing the memory system during a firmware mode transition. In some examples, aspects of the operations of 610 may be performed by an indication monitoring component 430 as described with reference to FIG. 4.

At 615, the method may include determining, based at least in part on the one or more indications, whether to transmit, to the memory system, a command to adjust a plurality of namespaces of the memory system and complete the firmware mode transition to the first firmware mode for the subsequent operations. In some examples, aspects of the operations of 615 may be performed by a transmission management component 435 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 15: A method, apparatus, or non-transitory computer-readable medium including operations, features, circuitry, logic, means, or instructions, or any combination thereof for transmitting, to a memory system, an indication of a first firmware mode for subsequent operations by the memory system, where the first firmware mode is associated with a first command set for accessing the memory system that is different than a second command set for accessing the memory system according to a second firmware mode used by the memory system prior to transmitting the indication of the first firmware mode; monitoring for one or more indications associated with a management mode of the memory system, where the management mode is associated with a reduced command set for accessing the memory system during a firmware mode transition; and determining, based at least in part on the one or more indications, whether to transmit, to the memory system, a command to adjust a plurality of namespaces of the memory system and complete the firmware mode transition to the first firmware mode for the subsequent operations.

Aspect 16: The method, apparatus, or non-transitory computer-readable medium of aspect 15, where the one or more indications include a threshold time period and the method, apparatuses, and non-transitory computer-readable medium further includes operations, features, circuitry, logic, means, or instructions, or any combination thereof for transmitting, based at least in part on an absence of signaling from the memory system during the threshold time period, the command to adjust the plurality of namespaces of the memory system and complete the firmware mode transition to the first firmware mode for the subsequent operations.

Aspect 17: The method, apparatus, or non-transitory computer-readable medium of any of aspects 15 through 16, further including operations, features, circuitry, logic, means, or instructions, or any combination thereof for receiving, based at least in part on monitoring for the one or more indications, a second indication that the memory system does not support the first firmware mode and transmitting, based at least in part on receiving the second indication, a third indication of the first firmware mode for the subsequent operations by the memory system.

Aspect 18: The method, apparatus, or non-transitory computer-readable medium of any of aspects 15 through 17, further including operations, features, circuitry, logic, means, or instructions, or any combination thereof for transmitting, after transmitting the indication of the first firmware mode, a second command to reset the memory system, where monitoring for the one or more indications associated with the management mode is based at least in part on the second command.

Aspect 19: The method, apparatus, or non-transitory computer-readable medium of any of aspects 15 through 18, where the command to adjust the plurality of namespaces of the memory system indicates to delete the plurality of namespaces of the memory system.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
operate in a first firmware mode of the memory system, the first firmware mode associated with a first command set for accessing the memory system;
receive an indication of a second firmware mode for the memory system, the second firmware mode associated with a second command set for accessing the memory system that is different than the first command set;
transition, based at least in part on the first command set being different than the second command set, from the first firmware mode to a management mode associated with a reduced command set relative to the first command set and the second command set, wherein the management mode supports one or more verification operations associated with a transition from the first firmware mode to the second firmware mode; and
determine whether to transition from the management mode to the second firmware mode based at least in part on the management mode supporting the one or more verification operations.

2. The memory system of claim 1, wherein the processing circuitry is further configured to cause the memory system to:
perform the one or more verification operations according to the management mode;
receive, based at least in part on the one or more verification operations and a threshold time period, a command to adjust one or more namespaces associated with the first firmware mode, wherein determining whether to transition from the management mode to the second firmware mode is further based at least in part on the command;
adjust the one or more namespaces based at least in part on the command; and
transition from the management mode to the second firmware mode based at least in part on adjusting the one or more namespaces.

3. The memory system of claim 1, wherein the processing circuitry is further configured to cause the memory system to:
perform the one or more verification operations according to the management mode;
receive, based at least in part on the one or more verification operations, a second indication of the first firmware mode, wherein determining whether to transition from the management mode to the second firmware mode is further based at least in part on the command; and
transition from the management mode to the first firmware mode based at least in part on the second indication.

4. The memory system of claim 1, wherein, to determine whether to transition from the management mode to the second firmware mode, the processing circuitry is configured to cause the memory system to:
determine, based at least in part on the one or more verification operations and in accordance with operating in the management mode, whether a quantity of available blocks in the memory system satisfies a threshold quantity associated with the transition to the second firmware mode.

5. The memory system of claim 4, wherein the processing circuitry is further configured to cause the memory system to:
determine that the quantity of available blocks satisfies the threshold quantity; and
transition from the management mode to the second firmware mode based at least in part on a command and the quantity of available blocks satisfying the threshold quantity.

6. The memory system of claim 4, wherein the processing circuitry is further configured to cause the memory system to:
determine that the quantity of available blocks does not satisfy the threshold quantity;
transmit, based at least in part on determining that the quantity of available blocks does not satisfy the threshold quantity, a second indication that the memory system does not support the transition from the first firmware mode to the second firmware mode;
receive, based at least in part on transmitting the second indication, a third indication of the first firmware mode; and
transition from the management mode to the first firmware mode based at least in part on the third indication.

7. The memory system of claim 1, wherein, to determine whether to transition from the management mode to the second firmware mode, the processing circuitry is configured to cause the memory system to:
determine to transition from the management mode to the second firmware mode based at least in part on an absence of namespaces in the memory system, wherein the one or more verification operations comprise a namespace identification operation.

8. The memory system of claim 1, wherein the processing circuitry is further configured to cause the memory system to:
detaching, based at least in part on the one or more verification operations and in accordance with operating in the management mode, one or more namespaces from the memory system, wherein determining whether to transition from the management mode to the second firmware mode is based at least in part on detaching the one or more namespaces.

9. The memory system of claim 1, wherein the processing circuitry is further configured to cause the memory system to:
store mode switch information that indicates a mode switch between the first firmware mode and the second firmware mode based at least in part on the second command set being different than the first command set.

10. The memory system of claim 9, wherein the processing circuitry is further configured to cause the memory system to:
receive, after receiving the indication of the second firmware mode, a reset command; and
determine, based at least in part on the reset command, that the mode switch information indicates the mode switch, wherein transitioning from the first firmware mode to the management mode is based at least in part on identifying that the mode switch information.

11. The memory system of claim 9, wherein the processing circuitry is further configured to cause the memory system to:
modify a value of the mode switch information based at least in part on transitioning from the first firmware mode to the management mode, wherein the modified mode switch information indicates that the memory system is operating in the management mode.

12. The memory system of claim 11, wherein the processing circuitry is further configured to cause the memory system to:
transition from a first power state to a second power state based at least in part on an asynchronous power loss at the memory system, the second power state greater than the first power state; and
operate in the management mode after transitioning from the first power state to the second power state based at least in part on modifying the mode switch information.

13. The memory system of claim 9, wherein the mode switch information is stored to non-volatile memory of the memory system.

14. The memory system of claim 1, wherein operating in the management mode comprises suspending one or more flash translation layer modules of the memory system, synchronizing one or more write cursors of the memory system, updating block retirement information of the memory system, resetting a logical-to-physical mapping for the memory system, resetting data stored to one or more datastores of the memory system, setting one or more datastore states of the memory system, flushing one or more portions of data to non-volatile memory of the memory system, or any combination thereof.

15. A host system, comprising:
one or more interfaces comprising one or more signal paths operable for communications with one or more memory systems; and
processing circuitry coupled with the one or more interfaces and configured to cause the host system to:
transmit, to a memory system of the one or more memory systems, an indication of a first firmware mode for subsequent operations by the memory system, wherein the first firmware mode is associated with a first command set for accessing the memory system that is different than a second command set for accessing the memory system according to a second firmware mode used by the memory system prior to transmitting the indication of the first firmware mode;
monitor for one or more indications associated with a management mode of the memory system, wherein the management mode is associated with a reduced command set for accessing the memory system during a firmware mode transition; and
determine, based at least in part on the one or more indications, whether to transmit, to the memory system, a command to adjust a plurality of namespaces of the memory system and complete the firmware mode transition to the first firmware mode for the subsequent operations.

16. The host system of claim 15, wherein the one or more indications comprise a threshold time period, and the processing circuitry is further configured to cause the host system to:
transmit, based at least in part on an absence of signaling from the memory system during the threshold time period, the command to adjust the plurality of namespaces of the memory system and complete the firmware mode transition to the first firmware mode for the subsequent operations.

17. The host system of claim 15, wherein the processing circuitry is further configured to cause the host system to:
receive, based at least in part on monitoring for the one or more indications, a second indication that the memory system does not support the first firmware mode; and
transmit, based at least in part on receiving the second indication, a third indication of the first firmware mode for the subsequent operations by the memory system.

18. The host system of claim 15, wherein the processing circuitry is further configured to cause the host system to:
transmit, after transmitting the indication of the first firmware mode, a second command to reset the memory system, wherein monitoring for the one or more indications associated with the management mode is based at least in part on the second command.

19. The host system of claim 15, wherein the command to adjust the plurality of namespaces of the memory system indicates to delete the plurality of namespaces of the memory system.

20. A method by a memory system, comprising:
operating in a first firmware mode of the memory system, the first firmware mode associated with a first command set for accessing the memory system;
receiving an indication of a second firmware mode for the memory system, the second firmware mode associated with a second command set for accessing the memory system that is different than the first command set;
transitioning, based at least in part on the first command set being different than the second command set, from the first firmware mode to a management mode associated with a reduced command set relative to the first command set and the second command set, wherein the management mode supports one or more verification operations associated with a transition from the first firmware mode to the second firmware mode; and
determining whether to transition from the management mode to the second firmware mode based at least in part on the management mode supporting the one or more verification operations.

21. The method of claim 20, further comprising:
performing the one or more verification operations according to the management mode;
receiving, based at least in part on the one or more verification operations and a threshold time period, a command to adjust one or more namespaces associated with the first firmware mode, wherein determining whether to transition from the management mode to the second firmware mode is further based at least in part on the command;
adjusting the one or more namespaces based at least in part on the command; and
transitioning from the management mode to the second firmware mode based at least in part on adjusting the one or more namespaces.

22. The method of claim 20, further comprising:
performing the one or more verification operations according to the management mode;
receiving, based at least in part on the one or more verification operations, a second indication of the first firmware mode, wherein determining whether to transition from the management mode to the second firmware mode is further based at least in part on the command; and
transitioning from the management mode to the first firmware mode based at least in part on the second indication.

23. The method of claim 20, wherein determining whether to transition from the management mode to the second firmware mode comprises:
determining, based at least in part on the one or more verification operations and in accordance with operating in the management mode, whether a quantity of available blocks in the memory system satisfies a threshold quantity associated with the transition to the second firmware mode.

24. The method of claim 23, further comprising:
determining that the quantity of available blocks satisfies the threshold quantity; and
transitioning from the management mode to the second firmware mode based at least in part on a command and the quantity of available blocks satisfying the threshold quantity.

25. The method of claim 23, further comprising:
determining that the quantity of available blocks does not satisfy the threshold quantity;
transmitting, based at least in part on determining that the quantity of available blocks does not satisfy the threshold quantity, a second indication that the memory system does not support the transition from the first firmware mode to the second firmware mode;
receiving, based at least in part on transmitting the second indication, a third indication of the first firmware mode; and
transitioning from the management mode to the first firmware mode based at least in part on the third indication.
